(19) United States
(12) Patent Application Publication
(10) Pub. No.: US 2022/0036180 A1
(43) Pub. Date: Feb. 3, 2022

(54) REINFORCEMENT LEARNING APPROACH TO APPROXIMATE A MENTAL MAP OF FORMAL LOGIC

(71) Applicant: Michelle N Archuleta, Lakewood, CO (US)

(72) Inventor: Michelle N Archuleta, Lakewood, CO (US)

(21) Appl. No.: 17/277,315

(22) PCT Filed: Sep. 24, 2019
(86) PCT No.: PCT/US19/52797

§ 371 Date: Mar. 18, 2021

Related U.S. Application Data
(60) Provisional application No. 62/735,600, filed on Sep. 24, 2018.

(51) Int. Cl. G06N 3/08; G06N 3/04

(52) U.S. Cl. CPC G06N 3/08; G06N 3/04

(57) ABSTRACT

Methods, systems, and apparatus, including computer programs language encoded on a computer storage medium for a logic correction system whereby input text is modified to a logical state using a reinforcement learning system with a real-time logic engine. The logic engine is able to extract the symmetry of word relationships and negate relationships into formal logical equations such that an automated theorem prover can evaluate the logical state of the input text and return a positive or negative reward. The reinforcement learning agent optimizes a policy creating a conceptual understanding of the logical system, a ‘mental map’ of word relationships.

### RELATED APPLICATIONS

This application claims priority to U.S. Provisional Patent Application No. 62/735,600 entitled “Reinforcement learning approach using a mental map to assess the logical context of sentences” Filed Sep. 24, 2018, the entirety of which is hereby incorporated by reference.

### TECHNICAL FIELD

The present invention relates generally to Artificial Intelligence and Artificial Generalized Intelligence related to logic, language, and network topology. In particular, the present invention is directed to word relationship, network symmetry, formal logic, and reinforcement learning. In particular, it relates to deriving a logical conceptual policy of word relationships.

### BACKGROUND ART

Medical errors are a leading cause of death in the United States (Wittich C M, Burkle C M, Lanier W L. Medication errors: an overview for clinicians. Mayo Clin. Proc. 2014 August; 89(8):1116-25). Each year, in the United States alone, 7,000 to 9,000 people die as a result of medication errors (Id. at pg. 1116). The total cost of caring for patients with medication-associated errors exceeds $40 billion dollars each year (Whittaker C F, Miklich M A, Patel R S, Fink J C. Medication Safety Principles and Practice in CKD. Clin J Am Soc Nephrol. 2018 Nov. 7; 13(11):1738-1746). Medication errors compound an underlying lack of trust between patients and the healthcare system.

Medical errors can occur at many steps in patient care, from writing down the medication, dictating into an electronic health record (EHR) system, making erroneous amendments or omissions, and finally to the time when the patient administers the drug. Medication errors are most common at the ordering or prescribing stage. A healthcare provider makes mistakes by writing the wrong medication, wrong route or dose, or the wrong frequency. Almost 50% of medication errors are related to medication-ordering errors. (Tariq R, Scherbak Y., Medication Errors StatPearls 2019; April 28)

The major causes of medication errors are distractions, distortions, and illegible writing. Nearly 75% of medication errors are attributed to distractions. Physicians have ever increasing pressure to see more and more patients and take on additional responsibilities. Despite an ever-increasing workload and oftentimes working in a rushed state a physician must write drug orders and prescriptions. (Tariq R, Scherbak Y., Medication Errors StatPearls 2019; April 28)

Distortions are another major cause of medication errors and can be attributed to misunderstood symbols, use of abbreviations, or improper translation. Illegible writing of prescriptions by a physician leads to major medication mistakes with nurses and pharmacists. Often times a practitioner or the pharmacist is not able to read the order and makes an educated guess.

The unmet need is to identifying logical medication errors and immediately inform healthcare workers. There are no solutions in the prior art that could fulfill the unmet need of identifying logical medication errors and immediately informing healthcare workers. The prior art is limited by software programs that require human input and human decision points, supervised machine learning algorithms that require massive amounts (10⁹-10¹⁰) of human generated paired labeled training datasets, and algorithms that are brittle and unable to perform well on datasets that were not present during training.

### SUMMARY

This specification describes a logical correction system that includes a reinforcement learning system and a real-time logic engine implemented as computer programs one or more computers in one or more locations. The logical correction system components include input data, computer hardware, computer software, and output data that can be viewed by a hardware display media or paper. A hardware display media may include a hardware display screen on a device (computer, tablet, mobile phone), projector, and other types of display media.

Generally, the system performs targeted edits on a class of words, characters, and/or punctuations that belong to a sentence or a set of sentences included in a discourse using a reinforcement learning system such that an agent learns a policy to perform the edits that result in a logical discourse. An environment that is the input discourse, an agent, a state (e.g. words or sentences belonging to the discourse), an action (e.g. swap polar words, antonym substitution, swap antonyms, change negation, etc.), and a reward (positive—logical discourse, negative—nonsensical discourse) are the components of a reinforcement learning system. The reinforcement learning system is coupled to a real-time logic engine such that each edit (action) made by an agent to the discourse results in a positive reward if the discourse is logical or a negative reward if the discourse is nonsensical.

The real-time logic engine transforms a discourse into a set of logical equations, categorizes the equations into assumptions and conclusion whereby the automated theorem prover using the assumptions infers a proof whereby the conclusion is logical or not. The real-time logic engine has the ability to transform a discourse into a set of assumptions and conclusion by executing the following instruction set on a processor: 1) a word network is constructed using the discourse and ‘a priori’ word groups, such that the word network is composed of node-edges defining word relationships; 2) ‘word polarity’ scores are computed to define nodes of symmetry; 3) a set of negation relationship are generated using the word network, antonyms, and word polarity scores; 4) a set of logical equations is generated using an automated theorem prover type, negated relationships, word network, and discourse.

In some aspects the discourse of sentences and groups are used to construct a network whereby a group A of words is used as the edges and a group B of words is used as the nodes such that group A and group B could be any possible groups of words, characters, punctuation, properties and/or attributes of the sentences or words.

In some aspects, the word polarity score is defined between two nodes in the network whereby the nodes have symmetrical relation with respect to each other such that the nodes share common connecting nodes and/or antonym nodes.

In some aspects, either the network, antonyms, and/or the polarity score are used to create negated relationships among nodes in the network.

In some aspects the negated relationships are formulated as a formal propositional logic whereby an automated propositional logic theorem prover evaluates the propositional logic equations and returns a positive reward if the discourse is logical and a negative reward if the discourse is nonsensical.

In some aspects the negated relationships are formulated as a formal first-order logic whereby an automated first-order logic theorem prover evaluates the first-order logic equations and returns a positive reward if the discourse is logical and a negative reward if the discourse is nonsensical.

In some aspects the negated relationships are formulated as a formal second-order logic whereby an automated second-order logic theorem prover evaluates the second-order logic equations and returns a positive reward if the discourse is logical and a negative reward if the discourse is nonsensical.

In some aspects the negated relationships are formulated as a formal higher-order logic whereby an automated higher-order logic theorem prover evaluates the higher-order logic equations and returns a positive reward if the discourse is logical and a negative reward if the discourse is nonsensical.

In some aspects a user may provide a set of logical equations that contain a specific formal logic to be used as assumptions in the real-time logic engine. In another embodiment a user may provide a set of logical equations that contain a specific formal logic to be used as the conclusion in the real-time logic engine. In another embodiment a user may provide the logical equations categorized into assumptions and conclusions.

In general, one or more innovative aspects may be embodied in a mental map. The reinforcement learning system optimizes a policy such that it has a conceptual understanding of the logical system defined as a ‘mental map’ of the discourse. The reinforcement-learning agent with an optimal policy has learned to navigate in its point-of-view the perception of the logical system to such an extent that errors are identified and automatically corrected. Mental maps can be saved to memory, stored and retrieved from memory and incorporated into a naïve reinforcement learning system through the weights of a convolutional neural network that was used by the reinforcement learning system as a function approximator wherein the reinforcement learning system is operating with an optimal policy.

### BRIEF DESCRIPTION OF THE DRAWINGS

FIG. 1 illustrates a logical correction system.

FIG. 2 depicts a reinforcement learning system with a logic engine and example actions.

FIG. 3 illustrates a reinforcement learning system with detailed components of the logic engine.

FIG. 4 depicts a flow diagram for reinforcement learning system with transferrable weights.

FIG. 5 depicts a mental map or optimized logical policy.

FIGS. 6A, 6B, & 6C illustrates logical mental map and logical equations for action swapping polar words.

FIGS. 7A & 7B illustrates logical mental map and logical equations for action substituting antonyms.

FIGS. 8A & 8B illustrates logical mental map and logical equations for action swapping antonyms.

FIGS. 9A & 9B illustrates logical mental map and logical equations for changing negation.

FIG. 10 depicts a flow diagram for logical language mapper.

FIGS. 11A & 11B illustrates generating word network from a sentence in a discourse.

FIG. 12 illustrates word networks arranged on a word polarity scale.

FIGS. 13A, 13B, & 13C illustrates word symmetry used generate negation relationships and logical form equations.

### DETAILED DESCRIPTION

Logical Correction System

This specification describes a logical correction system that includes a reinforcement learning system and a real-time logic engine implemented as computer programs one or more computers in one or more locations. The logic correction system components include input data, computer hardware, computer software, and output data that can be viewed by a hardware display media or paper. A hardware display media may include a hardware display screen on a device (e.g. computer, tablet, mobile phone), projector, and other types of display media.

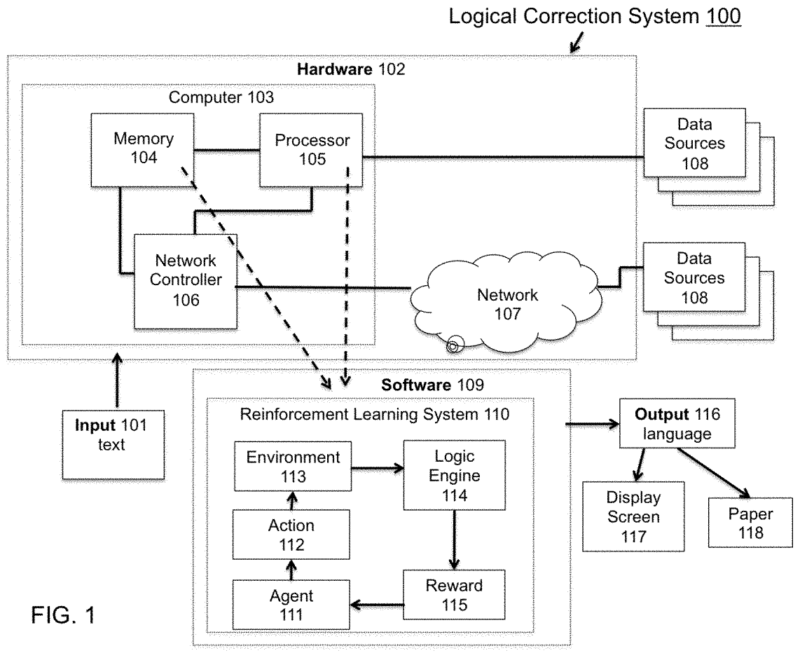

FIG. 1 illustrates a logical correction system 100 with the following components: input 101, hardware 102, software 108, and output 116. The input is text such as a language in from EHR, a medical journal, a prescription, a genetic test, and an insurance document, among others. The input 101 may be provided by an individual, individuals or a system and entered into a hardware device 102 such as a computer 103 with a memory 104, processor 105 and or network controller 106. A hardware device is able to access data sources 108 via internal storage or through the network controller 106, which connects to a network 107.

The data sources 108 that are retrieved by a hardware device 102 in one of other possible embodiments includes for example but not limited to: 1) an antonym and synonym database, 2) a thesaurus, 3) a corpus of co-occurrence words 4) a corpus of medical terms mapped to plain language definitions, 5) a corpus of medical abbreviations and corresponding medical terms, 6) a Formal logic grammar that incorporates all logical rules in a particular text input provided in any language, 7) a corpus of co-occurrence medical words, 8) a corpus of word-embeddings, 9) a corpus of part-of-speech tags, and 10) grammatical rules.

The data sources 108 and the text input 101 are stored in memory or a memory unit 103 and passed to a software 109 such as computer program or computer programs that executes the instruction set on a processor 105. The software 109 being a computer program executes a reinforcement learning system 110 on a processor 105 such that an agent 111 performs actions 112 on an environment 113, which calls a reinforcement learning reward mechanism, a logic engine 114, which provides a reward 115 to the system. The reinforcement learning system 110 makes edits to the sentence while ensuring that the edits result in a logical sentences. The output 116 from the system is logical language that can be viewed by a reader on a display screen 117 or printed on paper 118.

In one or more embodiments of the logical correction system 100 hardware 102 includes the computer 103 connected to the network 107. The computer 103 is configured with one or more processors 105, a memory or memory unit 104, and one or more network controllers 106. It can be understood that the components of the computer 103 are configured and connected in such a way as to be operational so that an operating system and application programs may reside in a memory or memory unit 104 and may be executed by the processor or processors 105 and data may be transmitted or received via the network controller 106 according to instructions executed by the processor or processor(s) 105. In one embodiment, a data source 108 may be connected directly to the computer 103 and accessible to the processor 105, for example in the case of an imaging sensor, telemetry sensor, or the like. In one embodiment, a data source 108 may be executed by the processor or processor(s) 105 and data may be transmitted or received via the network controller 106 according to instructions executed by the processor or processors 105. In one embodiment, a data source 108 may be connected to the reinforcement learning system 110 remotely via the network 107, for example in the case of media data obtained from the Internet. The configuration of the computer 103 may be that the one or more processors 105, memory 104, or network controllers 106 may physically reside on multiple physical components within the computer 103 or may be integrated into fewer physical components within the computer 103, without departing from the scope of the invention. In one embodiment, a plurality of computers 103 may be configured to execute some or all of the steps listed herein, such that the cumulative steps executed by the plurality of computers are in accordance with the invention.

A physical interface is provided for embodiments described in this specification and includes computer hardware and display hardware (e.g. computer screen). Those skilled in the art will appreciate that components described herein include computer hardware and/or executable software which is stored on a computer-readable medium for execution on appropriate computing hardware. The terms “computer-readable medium” or “machine readable medium” should be taken to include a single medium or multiple media that store one or more sets of instructions. The terms “computer-readable medium” or “machine readable medium” shall also be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random Access Memory (RAM), and/or Erasable Programmable Read-Only Memory (EPROM). The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. In other embodiments, some of these operations might be performed by specific hardware components that contain hardwired logic. Those operations might alternatively be performed by any combination of programmable computer components and fixed hardware circuit components.

In one or more embodiments of the logical correction system 100 software 109 includes the reinforcement learning system 110 which will be described in detail in the following section.

In one or more embodiments of the logical correction system 100 the output 116 includes language classified as follows: 1) logical language in which a correction was made 2) unaltered logical language 3) nonsensical language that could not be resolved by the system. A user receiving the output language 116 through a hardware display screen 117 will have the option of saving the fixed content and correction(s) that were made or disregarding the suggested output. A user can select this option through a hardware interface such as a keyboard, and/or cursor. The output language 116 will be delivered to an end user through a display screen 117 (e.g. tablet, mobile phone, computer screen) and/or paper 118.

Reinforcement Learning System

Further embodiments are directed to a reinforcement learning system that performs actions to a sentence or sentences whereby, a real-time logic-engine reward mechanism returns a reward that is dependent on the logical validity of the sentence or sentences. The embodiment of a reinforcement learning system with a real-time logic-engine reward mechanism enables actions such as but not limited to substituting antonyms within a sentence to make the sentence logical.

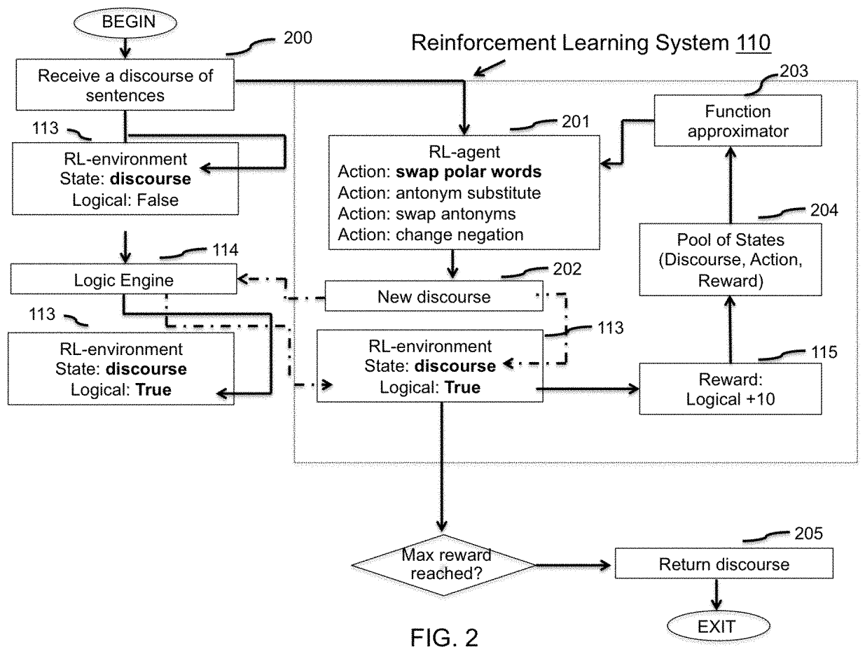

A reinforcement learning system 110 with logic-engine reward mechanism is defined by an input 101, hardware 102, software 108, and output 116. FIG. 2. illustrates an example output to the reinforcement learning system 110 that may include but is not limited to a sentence or set of sentences that make up a discourse 200 that is extracted from the input text 101. Another input includes data sources 108 that are provide to the logic engine 114 and function approximator 203 and will be described in the following sections.

The reinforcement learning system 110 uses a hardware 102, which consists of a memory or memory unit 104, and processor 105 such that software 109, a computer program or computer programs is executed on a processor 105 and performs edits to the sentence resulting in a logical sentence or sentences 204. The output from reinforcement learning system 110 in an embodiment is combined in the same order as the original input text such that the original language is reconstructed to produce output language 116. A user is able to view the output language 116 on a display screen 117 or printed paper 118.

FIG. 2 depicts a reinforcement learning system 110 with an discourse of sentence(s) 200 and an environment that holds state information consisting of the sentence, and the logical validity of the sentence 113; such that an agent performs actions 201 on a sentence; and a logic engine 114 is used as the reward mechanism returning a positive reward 115 if the sentence is logical in context to peer-reviewed ‘a prior’ logic rules and a negative reward if the sentence is nonsensical 115. An agent receiving the sentence is able to perform actions 112 (e.g. swap polar words, antonym substitution, swap antonyms, change negation, insertion, substitution, and/or rearrangement) on the sentence resulting in a new sentence or sentence(s) 202. The new sentence 202 is updated in the environment and then passed to a logic engine 114 which updates the environment with a value that specifies the logical state (True-logical sentence, False-non-logical sentence). The logic engine 114 also returns a reward 115 to the reinforcement-learning environment such that a change resulting in a logical sentence results in a positive reward and a change resulting in a nonsensical sentence results in a negative reward.

A pool of states 204 saves the state (e.g. discourse), action (e.g. deletion), reward (e.g. positive). After exploration and generating a large pool of states 204 a function approximator 203 is used to predict an action that will result in the greatest total reward. The reinforcement learning system 110 is thus learning a policy to perform edits to a discourse resulting in logically correct sentences. One or more embodiments specify termination once a maximum reward is reached and returns a set of logically correct sentence(s) 205. Additional embodiments may have alternative termination criteria such as termination upon executing a certain number of iterations among others. Also for given input discourse 200 it may not be possible to produce a logically discourse 205 in such instances the original sentence could be returned and highlighted such that an end user could differentiate between logical sentence and the original input text.

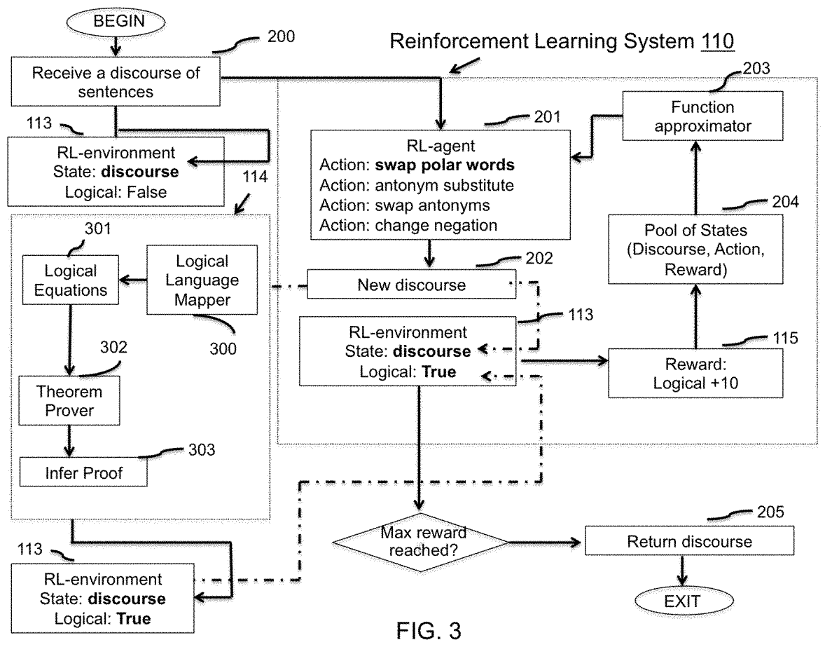

FIG. 3 illustrates a reinforcement learning system 110 with detailed components of the logic engine 114. A set of logical rules 300 is defined and used as an input data source 108 such that an automated theorem prover 303 infers a conclusion based on the premise that is establish by the logical rules 300. A logical language mapper function 301 is used to formalize the discourse 200 into a formal language (e.g. first order logic) such that the discourse 200 is compatible with the theorem prover 302. The theorem prover residing in memory and executed on a processor 405 utilizes the logical rules 300 as the premise and infers a proof 303 of the discourse 300. In essence, the theorem prover is validating that the stated assumptions (logical rules 300) logically guarantee the conclusion, discourse 300. The output of the logic engine 114 is a Boolean value that specifies whether the discourse was logical or not. A corresponding positive reward 115 is given for a logical discourse and a negative reward 115 is given for a non-logical discourse.

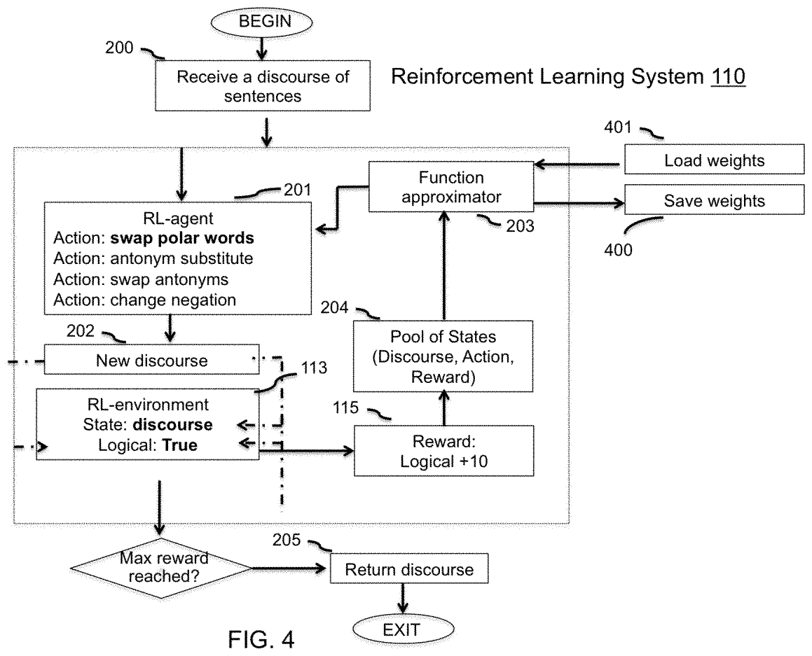

FIG. 4 illustrates a reinforcement learning system 110 with a transferrable learning mechanism. The transferrable learning mechanism being weights from a function approximator 203 (e.g. convolutional neural network CNN) that has optimized a learning policy whereby a minimal number of edits that result in a logical discourse has been learned. The weights from a function approximator can be stored in a memory 104 such that the weights are saved 400. The weights can be retrieved by a reinforcement learning system 110 and loaded into a function approximator 401. The transferrable learning mechanism enables the optimal policy from a reinforcement learning system 110 to be transferred to a naive reinforcement learning system 110 such that the system 110 will have a reduction in the amount of time required to learn the optimized policy.

Mental Map

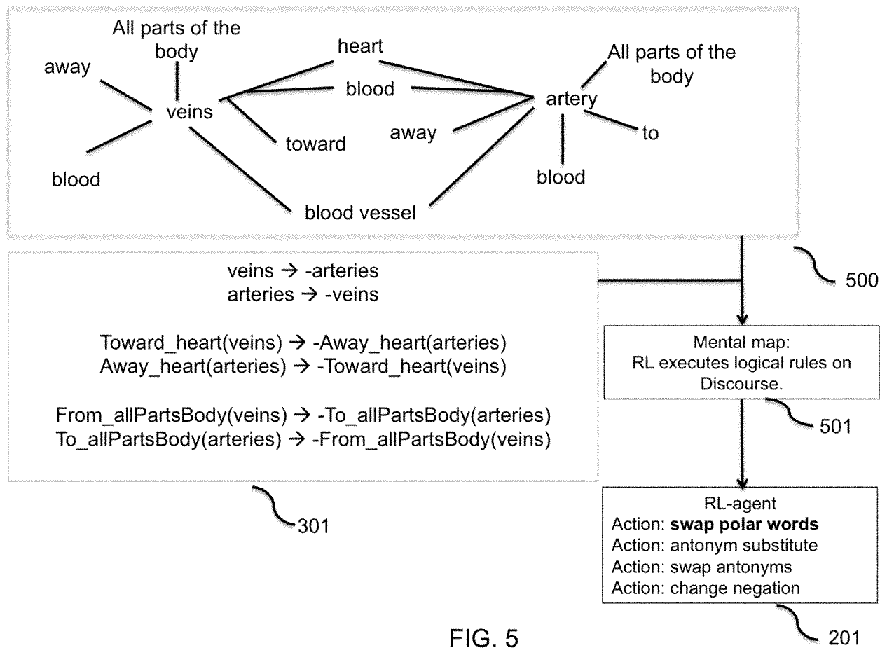

FIG. 5. illustrates the discourse 200 as a set of logical equations 112 output from the logical language mapper 301. The reinforcement learning system 110 is learning a policy whereby modifying sentences of a discourse results in a logical set of statements. Overtime the reinforcement learning system optimizes a policy such that it has a created a conceptual understanding of the logical system defined as a ‘mental map’.

Mental maps in behavioral geography are defined as a person's point-of-view perception of their area of interaction. The reinforcement-learning agent with an optimal policy has learned to navigate in its point-of-view the perception of the logical system to such an extent that errors are identified and automatically corrected. At the point that the reinforcement-learning agent achieves an optimal policy it is said to have a ‘mental map’ of the system of logic. An agent with a mental map can automatically execute any new information and derive its logical validity.

Mental maps 500 as demonstrated in FIG. 4. can undergo transferrable learning mechanism whereby an agent with an optimal policy for conceptualizing the logic of ‘arteries’ with respect to ‘veins’ can be saved. The ability to save an optimized policy for ‘arteries/veins’ or an ‘arteries/veins’ mental map is achieved by the weights of the CNN that are saved to memory. The CNN acts as an oracle for the reinforcement learning agent allowing the agent to learn from a pool of states (discourse, action, reward) 204 that it generated during explorative learning. The function approximator 203 in this example being a CNN allows the agent to select the most optimal action for maximum future reward. The CNN allows the reinforcement learning agent to use exploitative learning or learning from past experience, utilizing the pool of states (discourse, action, reward) 204 such that it can achieve maximum future reward.

In a similar fashion a ‘kidney/heart’ mental map can be saved as the weights of the CNN that correspond to a state of optimal policy that has been learned by the reinforcement learning agent on a set of logical premises and conclusions that govern the relationships between ‘kidney’ and ‘heart’. An embodiment is such that the CNN is taking a ‘snap shot’ of the logic engine (automated theorem prover and the set of logical equations). Learning is happening in a unilateral direction between the logic engine into the oracle the CNN.

The mechanism of transferrable learning allows an ‘arteries/veins’ mental map to be loaded into memory and executed by processor whereby the CNN with the loaded weights is used to make a prediction. A reinforcement learning system could have two sets of oracles, two CNNs that have different mental map representation. A ‘kidney/heart’ mental map could coincide with the ‘arteries/veins’ mental map. The embodiment is extended to many layers of mental maps creating an artificial brain of logic.

FIG. 5. illustrates a mental map 500 such that a reinforcement learning agent executes a set of logical equations 300 on a discourse 501 to determine the logical state of the environment. The reinforcement learning agent selects a set of actions 201 such as swapping polar words, substituting antonyms, swapping antonyms, and/or changing negation. The following section describes the use of a mental map to select and implement actions to restore the discourse to a logical state.

Actions

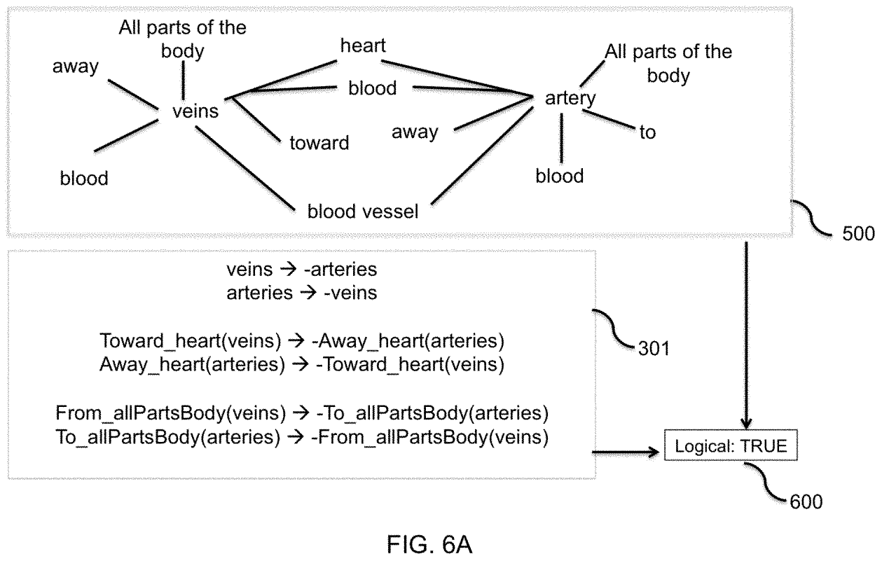

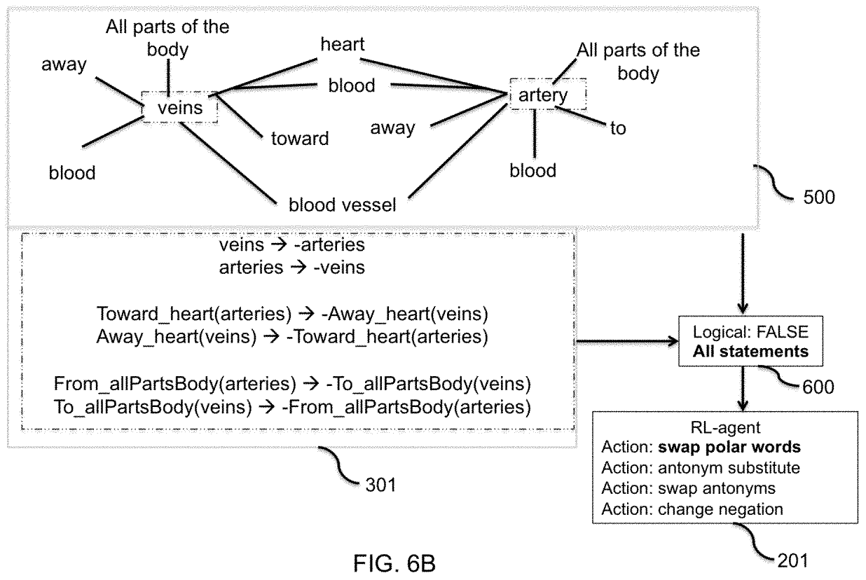

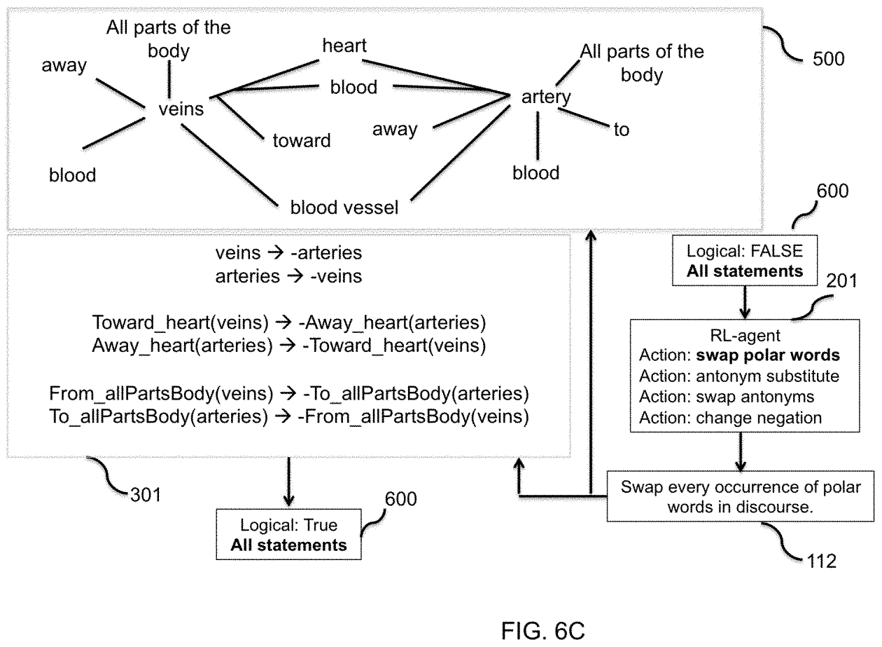

FIG. 6A illustrates a set of logic equations 300 evaluated using a mental map 500 resulting in a logical state 600 of True. FIG. 6B shows an instant in which the polar words ‘veins’ and ‘arteries’ have been swapped within the logical equations 300. Evaluating the discourse against the mental map 500 or the logic engine 114 returns a logical Boolean 600 of False. An RL-agent can then perform a set of actions 201 on the discourse, whereby the RL-agent is leveraging a mental map of conceptual understanding of the words and word relationships of ‘veins’ and ‘arteries’. The RL-agent selects the action of swapping polar words 105, such that polar word ‘arteries’ is substituted with polar word ‘veins’ and vice versa for every occurrence of the polar words in the logical equations 300. FIG. 6C illustrates the logic equations 300 return a logical Boolean of True demonstrating logical validity.

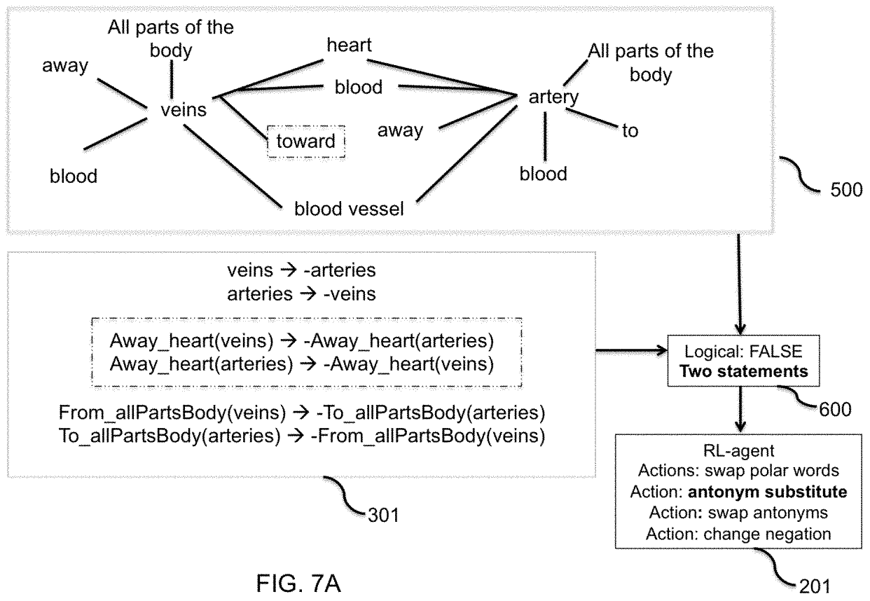

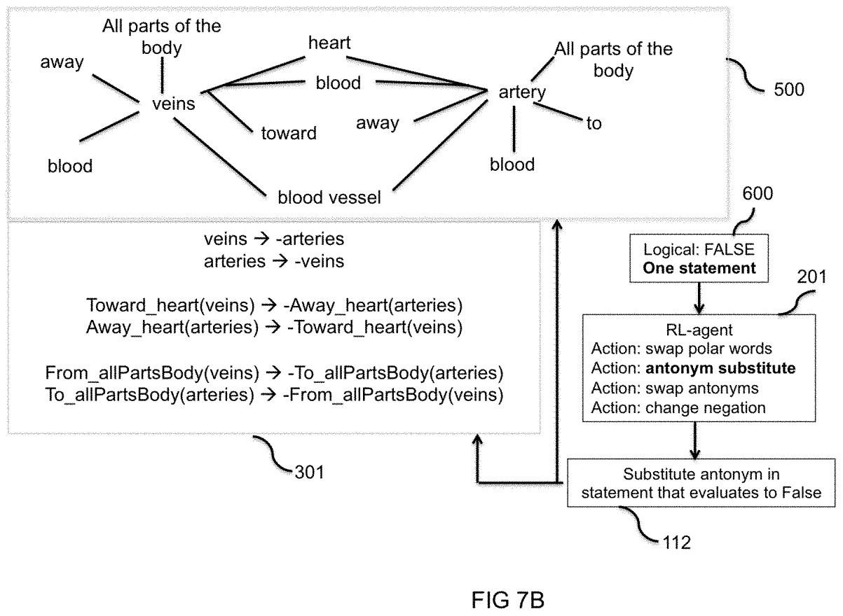

FIG. 7A illustrates the logical equation 300 (dashed box) such that ‘veins’ has the word ‘away’ instead of its antonym ‘toward’ when describing the relationship of ‘veins’ and ‘heart’ resulting in a logical Boolean of False 600. The RL-agent utilizes the mental map as encoded within the oracle, CNN's weights such that an optimal policy will be performed. The mental map informs the RL-agent to select the action of antonym substitution. The RL-agent will then substitute the word ‘away’ with its antonym ‘toward’ 112 returning the logical Boolean of True as shown in FIG. 7B.

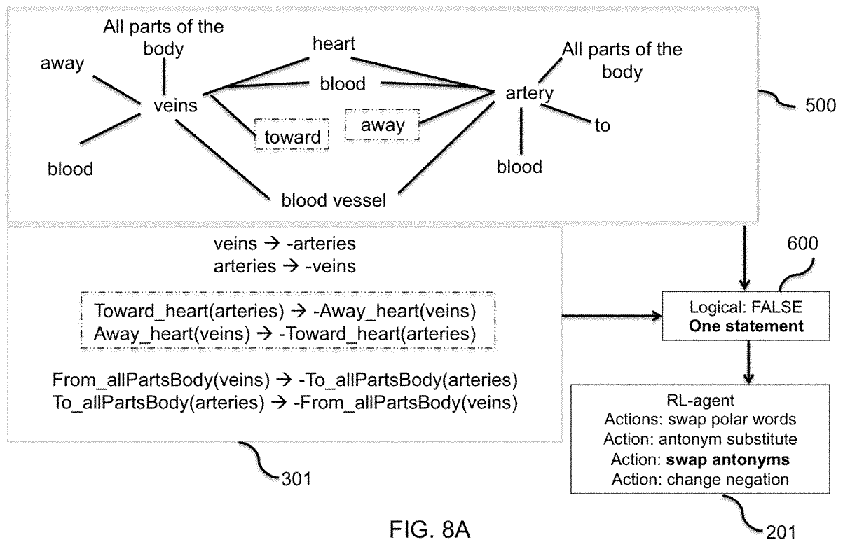

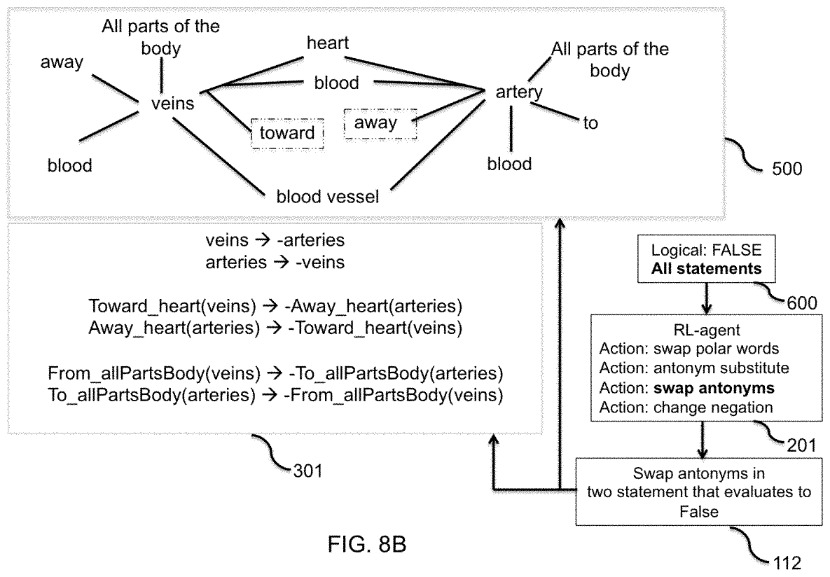

FIG. 8A illustrates the logical equation 300 (dashed box) in which the antonyms ‘toward’ and ‘away’ describing the words ‘veins’ and ‘arteries’ with respect to ‘heart’ are inverted resulting in a logical Boolean of False 600. The RL-agent utilizes the mental map, an optimal policy of the logical system of ‘veins’ and ‘arteries’, thereby selecting the action of swapping antonyms. FIG. 8B illustrates how when the RL-agent swaps antonyms 112 in the discourse 200 resulting in logical equations 300 that restore the system to a logical state.

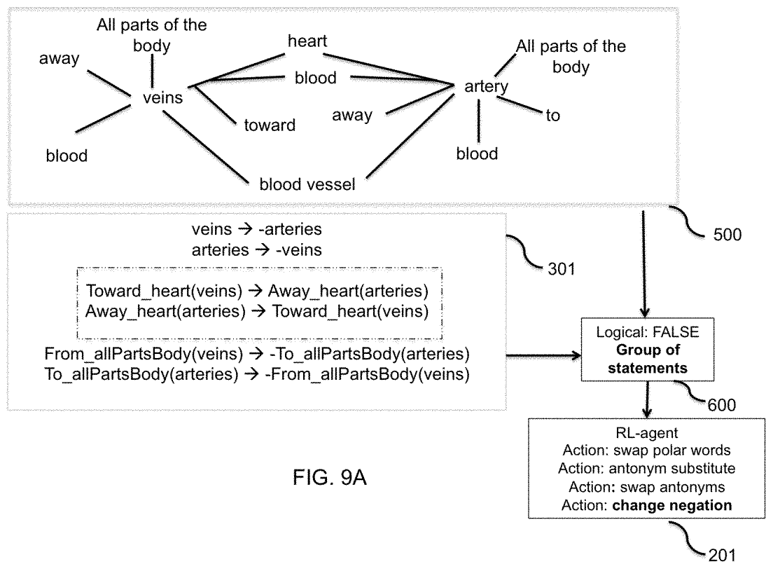

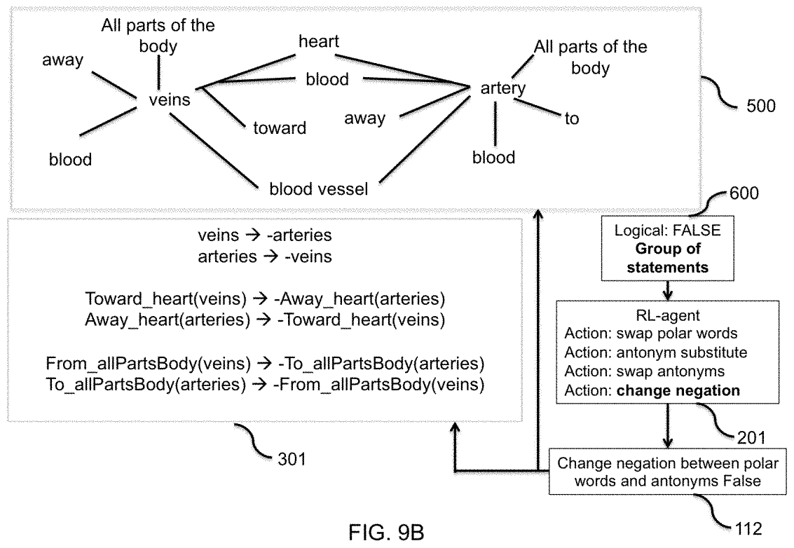

FIG. 9A illustrates the logical equation 300 (dashed box) such that discourse is missing negations between ‘arteries’ and ‘veins’ resulting in a logical Boolean of False 600. The RL-agent adds negation to the polar words and/or antonyms 112 and restores the discourse to a logical state.

Real-Time Logic Engine

One or more aspects includes a real-time logic engine, which consists of a logical language mapper that transforms the new discourse 202 into a set of logical equations that are evaluated in real-time using the automated theorem prover 302. A real-time logic engine is defined by an input (202), hardware 102, software 114, and output (113 & 115). A real-time logic engine at operation is defined with the following components: 1) input discourse 202 that has been modified by a reinforcement learning system 110; 2) a software 300 & 302 or computer program; 3) hardware 102 that includes a memory 104 and a processor 105 4) an output a value that specifies a logical or nonsensical discourse 202. The output value updates the reinforcement learning system environment (113) and provides a reward (115) to the agent (111).

One or more aspects of the logical equations, as defined in formal language theory, is a certain type of formal logic such that premises or assumptions are used to infer a conclusion. These logical equations can be derived regardless of content. Mathematical logic derives from mathematical concepts expressed using formal logical systems. The systems of propositional logic and first order logic (FOL) are less expressive but are desirable for proof theoretic properties. Second order logic (SOL) and higher order logic (HOL) are more expressive but are more difficult to infer proofs.

Logical Language Mapper

The input discourse with a set of a finite number of sentences is transformed into a set of logical equations such that the logical equations are compatible with the automated theorem prover. The following steps are executed by a processor with a software and input data residing in memory: 1) sentences are transformed into a network of word relationships; 2) antonyms are identified in the network; 3) word polarity score is calculated for each node with respect to all neighboring nodes; 4) using polar word scores, antonyms, and the symmetry of the word network equations are generated that reflect the symmetry of word relationships in the network; 5) input theorem prover type informs the logical language mapper such that semantics are extracted from the original sentences and used to output the appropriate logical form for the equations.

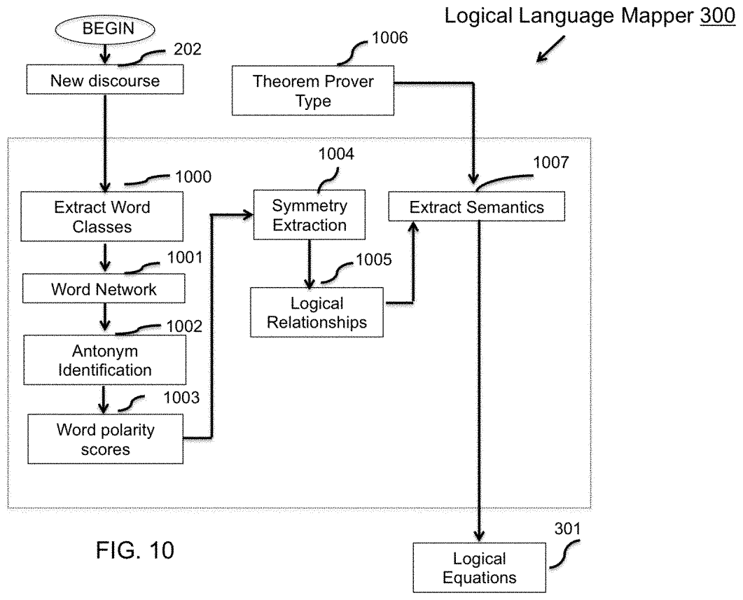

FIG. 10 illustrates the logical language mapper 300 which takes as input the new discourse 202 residing in memory. A computer program or computer program(s) residing in memory and executed as an instruction set on a processor 105 transforms the new discourse 202 into a set of logical equations 301 residing in memory. FIG. 10 shows the following steps executed as an instruction set on a processor 105: 1) extract word classes 1000; 2) create a word network 1001; 3) identify antonyms 1002; 4) compute word polarity scores 1003, for each node with respect to all neighboring nodes; 5) use symmetry of the network to extract negation relationships 1004 in the word network 1001; 6) use as input theorem prover type 1006 as an argument residing in memory such that the computer program or computer programs residing in memory and executed as an instruction set on a processor 105 extract the semantics from the word network 1001 and/or the new discourse 202 and use the extracted semantics 1007 to generate a set of logical equations 301 that are compatible with the automated theorem prover 302.

Word Network

The word network 1001 is a graphical representation of the relationships between words represented as nodes and relationship between words are edges. Nodes and edges can be used to represent any or a combination of parts-of-speech tags in a sentence or word groups within the sentence defined as word classes 1000. An embodiment of a word network may include extracting the subject and object, word class 1000 from a sentence such that the subject and object are the nodes in the network and the verb or adjective is represented as the edge of the network. Another embodiment may extract verbs as the nodes and subjects and/or objects as the edges. Additional combination of words and a priori categorization of word relationships defined as word classes 1000 are within the scope of this specification for constructing a word network 1001.

The following steps provide an example of how a word network could be constructed for a Wikipedia medical page such that an input 101 of the first five sentences of Wikipedia medical page is provided to the system and an output of the medical word network 1001 is produced from the system. The first step, the new discourse 202 is defined as Wikipedia medical page and the first five sentences are extracted from the input corpus 101. The second step, a list of English equivalency words is defined. In this embodiment the English equivalency words are the following ‘is’, ‘are’, ‘also referred as’, ‘better known as’, ‘also called’, ‘another name’ and ‘also known as’ among others. The third step, filter the extracted sentences to a list of sentences that contain an English equivalency word or word phrase. The fourth step, apply a part-of-speech classifier to each sentence in the filtered list. The fifth step, group noun phrases together. The sixth step, identify and label each word as a subject, objective, or null. The seventh step, create a mapping of subject, verb, object to preserve the relationship. The eighth step, remove any words in the sentence that are not a noun or adjective, creating a filtered list of tuples (subject, object) and a corresponding mapped ID. The ninth step, identify and label whether or not a word in the tuple (subject, object) exist in the network. The tenth step, for tuples that do not exist in the network add a node for the subject and object, the mapped ID for the edge, and append to the word network 1001. The eleventh step, for tuples that contain one word that does exist in the network, add the mapped ID for the edge, and the remaining word that does not exist in the word network as a connecting node. The twelfth step, for tuples that exist in the network pull the edge with a list of mapped IDs if the mapped ID corresponding to the tuple does not exist append the mapped ID to the list of mapped IDs that correspond with the edge otherwise continue.

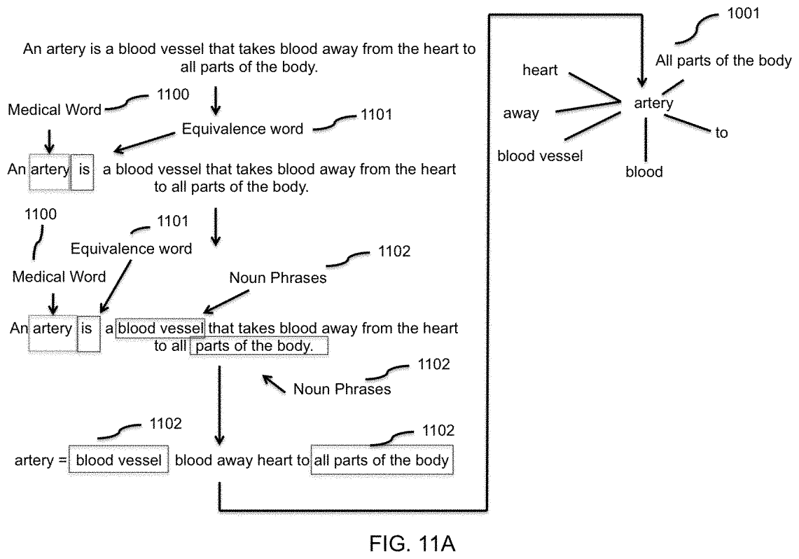

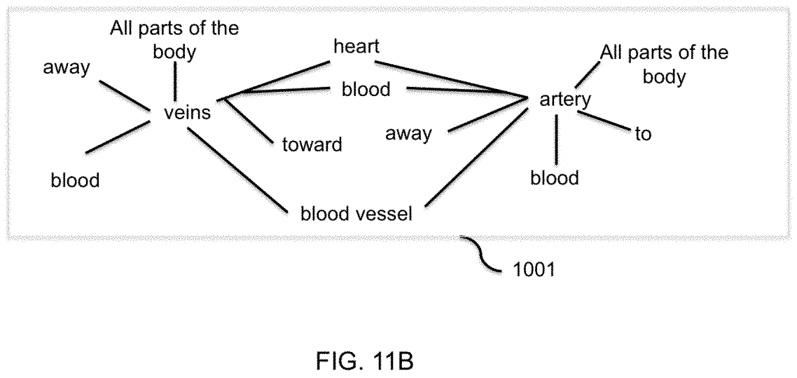

FIGS. 11A & 11B shows how a medical sentence is turned into a medical word network 1001. A medical word 1100 is defined by first identifying an English equivalence word 1101, which in this example is the word ‘is’. Noun phrases 1102 within the sentence are grouped together. Then the medical word 1100 is equated to the words on the right side of the equivalence word. All words that are not noun or adjective are removed from the sentences except for words that are part of the grouped noun phrases 1102. A word network 1001 is constructed for the word ‘artery’. The same process is repeated for the word ‘veins’. The resulting word network 1001 that connects nodes between the medical words 1100 ‘veins’ and ‘arteries’ is shown in FIG. 11B.

Word Polarity

A word polarity system performs step 1003 with the following components: input 101, hardware 102, software 109, and output 116. The word polarity method requires an input word network 1001, and antonym identification 1002, hardware 102 consisting of a memory 104 and a processor 105, a software 109 (word polarity computer program) and output word polarity scores 1003 residing in memory. The word polarity system can be configured with user specified data sources 108 to return nodes in the word network 1001 that are above a word polarity threshold score. The word polarity identification system can be configured with user specified data sources 108 to use an ensemble of word polarity scoring methods or a specific word polarity scoring method.

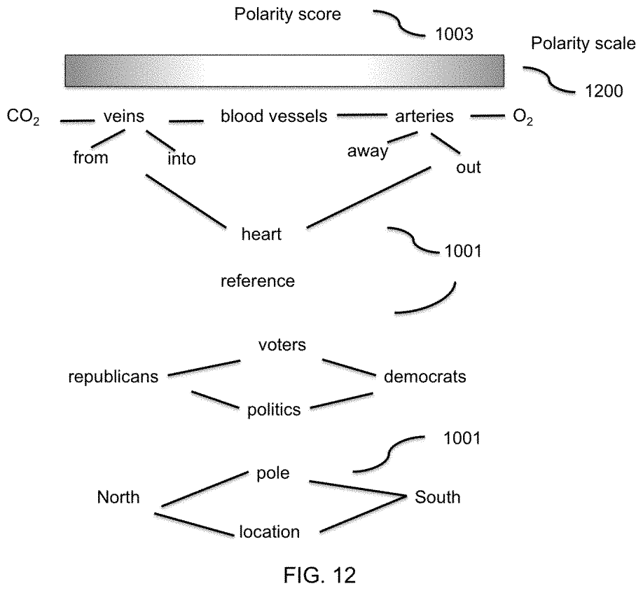

FIG. 12 shows three examples of ‘polar’ words that can be identified from the word network 1001. In this first network the words with the highest polarity scores, 1003 as defined by the polarity scale 1200 are the words ‘veins’ and ‘arteries’. The words ‘veins’ and ‘arteries’ are symmetrical indicating that they are polar opposites. Arteries being defined as ‘blood vessels that carry oxygenated blood (O2) away from the heart’ which is symmetrical in meaning with veins, defined as ‘blood vessels that carry deoxygenated blood to the heart’. The word ‘arteries’ and ‘veins’ are symmetrical in other aspects consider these definitions: ‘Arteries bring oxygen rich blood to all other parts of the body.’ and ‘Veins carry carbon dioxide rich blood away from the rest of the body.’ Polar words have reference words in common for the example of ‘arteries’ and ‘veins’ the shared reference words are ‘blood vessels’ and ‘heart’. They also have antonym words shared between them such as ‘carry out’ (arteries) and ‘carry into’ (veins), ‘oxygenated blood O₂ (arteries)’ and ‘deoxygenated blood CO₂ (veins)’, and ‘carry blood to the body (arteries)’ and ‘carry blood away from the body (veins)’.

Similar words that are symmetrical include ‘Republicans’ and ‘Democrats’ (FIG. 4A), ‘North’ and ‘South’ (FIG. 12) The reference words for ‘Republicans’ and ‘Democrats’ are ‘voters’, ‘politics’, ‘convention’, ‘primary’, etc. among others and reference words for ‘North’ and ‘South are ‘pole’, ‘location’, ‘map’ etc. Symmetrical words are similar in size in terms of the number of nodes that they are connected to.

Neutral words with low word polarity scores are words such as ‘blood vessels’, ‘heart’, and ‘location’. The word ‘heart’ in relation to medicine has no ‘polar word’ that has opposite and relating functions and attributes. However, outside of medicine in literature for example the word ‘heart’ may have a different polarity score perhaps ‘heart’ relates to ‘love’ vs. ‘hate’. The polarity scores of words can change depending on their underlying corpus.

In some implementations the word polarity computer program, computes a word polarity score 1003 for each node in relation to another node in the word network 1001. The polarity score 1003 is calculated based on shared reference nodes N_{ref} and shared antonym nodes N_{An}. The node polarity connections are defined as N_{polarity}=wₛN_{Ref}+w_{A}N_{Ant}. A global maximum polarity score is Max_{polarity}=max(N_{polarity}) is computed across the word network 1001. The word polarity score 1003 is computed as P_{score}=N_{polarity}/Max_{polarity} with respect to each node Nᵢ interacting with node Nⱼ.

In some implementations the word polarity computer program, computes a word polarity score 1003 by identifying the axis with the largest number of symmetrical nodes within the word network 1001. The summation of nodes along the axis that maximizes symmetry defines a node polarity connection score N_{polarity}=Σ_{i,j∈S}_{ₖ}nᵢⱼ such that i,j represent nodes in relation to each other in the subnetwork Sₖ computed for all nodes in the word network 1001. A global maximum polarity score is Max_{polarity}=max(N_{polarity}) is computed across the word network 1001. The word polarity score 1003 is computed as P_{score}=N_{polarity}/Max_{polarity} with respect to each node Nᵢ interacting with node Nⱼ.

Symmetry Extraction

A symmetry extraction method performs step 1004 with the following components: input 101, hardware 102, software 109, and output 301. The symmetry extraction method requires an input word network 1001, and antonym identification 1002, hardware 102 consisting of a memory 104 and a processor 105, a software 109 and output logical equations 301 residing in memory. The symmetry extraction can be configured with user specified data sources 108, theorem prover type 1006 to return logical equations 301 with the following steps: 1) symmetry is used to generate negations between polar words in the word network resulting in negated logical relationships 2) using the input of a theorem prover type 1006 extract semantics 1007 to formalize the logical relationships 1005 into a formal logic (e.g. FOL) resulting in the output of logical equations 301.

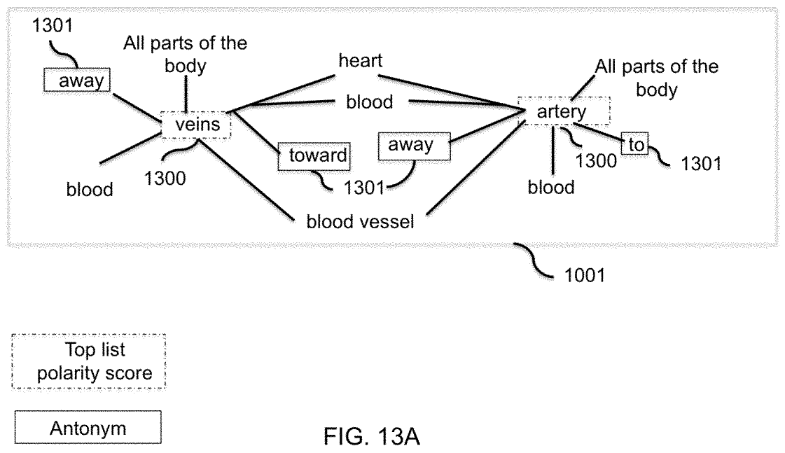

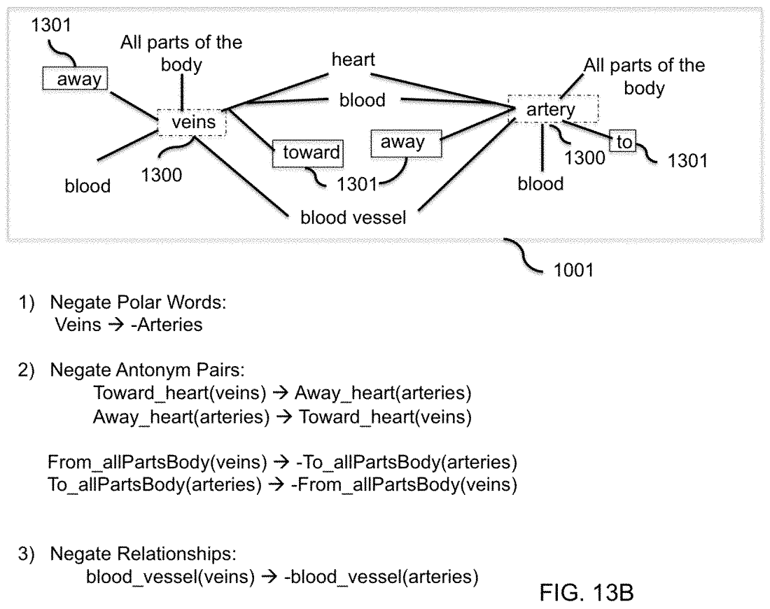

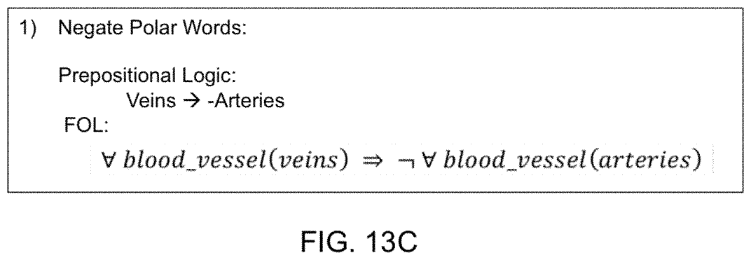

FIGS. 13A, 13B, & 13C illustrates the steps for generating logical relationships 1005 that are then formulated into logical equations 301 using as input the word polarity scores 1003, word network 1001, and antonyms 1301. FIG. 13A shows a word network 1001 in which the nodes in the top list of word polarity scores 1300 are shown in the dashed boxes and the antonyms 1301 are shown in the solid boxes. The steps for generating logical relationships 1005 from the word network 1001 are shown in FIG. 13B. The steps are the following: 1) negate polar words, 2) negate antonym pairs, 3) negate relationships. FIG. 13C shows an example of extracting semantics from the sentences of the new discourse 202 and/or word network 1001 in a formal language and thus generating logical equations 301.

FIG. 13C shows the example of negating the polar words and outputting propositional logic and FOL. It should be noted that someone skilled in the art is able to transform English sentences into a formal language of logic. The symmetry extraction method transforms the English sentences into a formal language of logic as shown in FIG. 13C whereby a set of rules maps English sentences into formal languages. It should be noted that it maybe impossible to transform some sentences and word network relationships into types of logic (e.g. HOL) and/or any logical form. If it is not possible to transform some sentences into a logical form the following steps will be performed: 1) automatically changing the automated theorem prover and deriving the set of logical equations for that theorem prover until all options are exhausted; 2) returning an error and/or logging the error.

Theorem Prover

In some implementations a theorem prover computer program, evaluates symbolic logic using an automated theorem prover derived from first-order and equational logic. Prover9 is an example of a first-order and equational logic automated theorem prover (W. McCune, “Prover9 and Mace4”, http://www.cs.unm.edu/˜mccune/Prover9, 2005-2010.).

In some implementations a theorem prover computer program, evaluates symbolic logic using a resolution based theorem prover. The Bliksem prover, a resolution based theorem prover, optimizes subsumption algorithms and indexing techniques. The Bliksem prover provides many different transformations to clausal normal form and resolution decision procedures (Hans de Nivelle. A resolution decision procedure for the guarded fragment. Proceedings of the 15^{th} Conference on Automated Deduction, number 1421 in LNAI, Lindau, Germany, 1998).

In some implementations a theorem prover computer program, evaluates symbolic logic using a first-order logic (FOL) with equality. The following are examples of a first-order logic theorem prover: SPASS (Weidenbach, C; Dimova, D; Fietzke, A; Kumar, R; Suda, M; Wischnewski, P 2009, “SPASS Version 3.5”, CADE-22: 22nd International Conference on Automated Deduction, Springer, pp. 140-145.), E theorem prover (Schulz, Stephan (2002). “E—A Brainiac Theorem Prover” Journal of AI Communications. 15 (2/3): 111-126.), leanCoP

In some implementations a theorem prover computer program, evaluates symbolic logic using an analytic tableau method. LangPro is an example analytic tableau method designed for natural logic. LangPro derives the logical forms from syntactic trees, such as Combinatory Categorical Grammar derivation trees. (Abzianidze L., LANGPRO: Natural Language Theorem Prover 2017 In Proceedings of the 2017 Conference on Empirical Methods in Natural Language Processing: System Demonstrations, pages 115-120).

In some implementations a theorem prover computer program, evaluates symbolic logic using an reinforcement learning based approach. The Bare Prover optimizes a reinforcement learning agent over previous proof attempts (Kaliszyk C., Urban J., Michalewski H., and Olsak M. Reinforcement learning of theorem proving. arXiv preprint arXiv:1805.07563, 2018). The Learned Prover uses efficient heuristics for automated reasoning using reinforcement learning (Gil Lederman, Markus N Rabe, and Sanjit A Seshia. Learning heuristics for automated reasoning through deep reinforcement learning. arXiv:1807.08058, 2018.) The π₄ Prover is a deep reinforcement learning algorithm for automated theorem proving in intuitionistic propositional logic (Kusumoto M, Yahata K, and Sakai M. Automated theorem proving in intuitionistic propositional logic by deep reinforcement learning. arXiv preprint arXiv:1811.00796, 2018.)

In some implementations a theorem prover computer program, evaluates symbolic logic using higher order logic. The Holophrasm is an example automated theorem proving in higher order logic that utilizes deep learning and eschewing hand-constructed features. Holophrasm exploits the formalism of the Metamath language and explores partial proof trees using a neural-network-augmented bandit algorithm and a sequence-to-sequence model for action enumeration (Whalen D. Holophrasm: a neural automated theorem prover for higher-order logic. arXiv preprint arXiv:1608.02644, 2016.)

Real-Time Logic Engine

The logic engine residing in memory and executed on a processor evaluates the input discourse 202 residing in memory, the logical proof equations residing in memory and calls a theorem prover 302 that executes the instruction set on a processor 105. An example embodiment is described using Prover9 as the automated theorem prover 302. Prover9, a first-order and equational logic (classic logic), uses an ASCII representation of FOL. The logical equations are divided into categories based on a set of assumptions as represented by symmetrical node relationships in the word network and a goal statement as represented by a sentence of the discourse. Prover9 is given a set of assumptions, the logical equations 301 and a goal statement. Mace4 is a tool used with Prover9 that searched for finite structures satisfying first-order and equational statements. Mace4 produces statements that satisfy the input formulas (logical equations 301) such that the statements are interpretations and therefore models of the input formulas. Prover9 negates the goal (remaining logical equation), transforms all assumptions (logical equations 301) and the goal into simpler clauses, and then attempts to find a proof by contradiction (W. McCune, “Prover9 and Mace4”, http://www.cs.unm.edu/˜mccune/Prover9, 2005-2010.).

In some implementations the logical equations are divided into categories: a set of assumptions and a goal statement. The logic engine iterates over the set of categories such that each logical equation is evaluated as a goal statement. Prover9 is given a set of assumptions, the logical equations 301 and a goal statement, the remaining logical equation.

In some implementations the logical equations maybe categorized into assumptions and goal statements based on user input.

In some implementations the logical equations used as a set of assumptions may be provided by the user as a data source 108.

Operation of the Real-Time Logic Engine

In operation, the logic engine 118 passes the new discourse 202 residing in memory, provided by the reinforcement learning environment, and the logical equations 301 residing in memory and executes the theorem prover 302 computer program on instruction set on a processor 105 whereby the theorem prover 302 computer program performs the following operations: 1) negates the goal (sentence ii of discourse 202); 2) transforms all assumptions (logical proof equations (without logical proof equation ii of discourse 302) and the goal (sentence ii of discourse 202) into simpler clauses; 3) attempts to find a proof by contradiction; and generates the following output result 113, a Boolean value that is used to update the reinforcement learning environment and 115 a reward such that a logical discourse returns a positive reward 115 and a nonsensical discourse returns a negative reward 115.

An advantage of a logic engine is that it has sustained performance in new environments. An example is that the logic engine can correct a discourse from a doctor's medical prescription and another sentence from a legal contract. The reason being that the logic engine rewards an agent based on whether or not the discourse 202 is logical. The logical state of the discourse is a general property of either the discourse from a doctor's note or a discourse in a legal contract. In essence in selecting a reward function, the limited constraint introduced in the aspect of the reinforcement learning logic-engine was the design decision of selecting a reward function whose properties are general to new environments.

Generalizable Reward Mechanism Performs Well in New Environments.

Reinforcement learning with traditional reward mechanism does not perform well with new environments. An advantage of one or more embodiments of the reinforcement learning system described in this specification is that the real-time logic engine reward mechanism represents a generalizable reward mechanism or generalizable reward function. A generalizable reward mechanism, generalizable function, is able to correctly characterize and specify intrinsic properties of any newly encountered environment. The environment of the reinforcement learning system is a discourse of sentences.

The intrinsic property of logicality is applicable to any newly encountered environment (e.g. discourse or discourse). An example of different environments is a corpus of health records vs. a corpus of legal documents. The different environments may be different linguistic characteristics of one individual writer vs. another individual writer (e.g. Emergency Room (ER) physician writes in shorthand vs. a general physician who writes in longhand).

Operation of Reinforcement Learning System

One of the embodiments provides the logic engine such that a discourse can be evaluated in real-time and a set of actions performed on the discourse that is not logical in order to restore the logical structure to the sentences of the discourse. In this embodiment a discourse and thus its attributes (e.g. logical state) represents the environment. An agent can interact with a discourse and receive a reward such that the environment and agent represent a Markov Decision Process (MDP). The MDP is a discrete time stochastic process such that at each time step the MDP represents some state s, (e.g. discourse) and the agent may choose any action a that is available in state s. The process responds at the next time step by randomly moving all members (e.g. all antonyms) involved in the action into a new state s′2 and passing new state s′2 residing in memory to a real-time logic engine that when executed on a processor returns a corresponding reward Rₐ (s,s2) for s′2.

The benefits of this and other embodiments include the ability to evaluate and correct the discourse of sentences in real-time. This embodiment has application in many areas of artificial intelligence and natural language process, in which a discourse maybe modified and then evaluated for its logical validity. These applications may include sentence simplification, machine translation, sentence generation, question and answering systems and text summarization among others. These and other benefits of one or more aspects will become apparent from consideration of the ensuing description.

One of the embodiments provides an agent with a set of sentences within a discourse or a complete discourse and attributes of which include a model and actions, which can be taken by the agent. The agent is initialized with number of features per word, 128, which is the standard recommendation. The agent is initialized with max words per sentence 20, which is used as an upper limit to constrain the search space. The agent is initialized with a starting index within the input discourse.

The agent is initialized with a set of hyperparameters, which includes epsilon ε (ε=1), epsilon decay, ε_decay (ε_decay=0.999), gamma, γ (γ=0.99), and a loss rate η (η=0.001). The hyperparameter epsilon ε is used to encourage the agent to explore random actions. The hyperparameter epsilon ε, specifies an ε-greedy policy whereby both greedy actions (e.g. exploitative learning) with an estimated greatest action value and non-greedy actions (e.g. explorative learning) with an unknown action value are sampled. When a selected random number, r is less than epsilon ε, a random action a is selected. After each episode epsilon ε is decayed by a factor ε_decay. As the time progresses epsilon ε, becomes less and as a result fewer non-greedy actions are sampled.

The hyperparameter gamma, γ is the discount factor per future reward. The objective of an agent is to find and exploit (control) an optimal action-value function that provides the greatest return of total reward. The standard assumption is that future rewards should be discounted by a factor γ per time step.

The final parameter the loss rate, η is used to reduce the learning rate over time for the stochastic gradient descent optimizer. The stochastic gradient descent optimizer is used to train the convolutional neural network through back propagation. The benefits of the loss rate are to increase performance and reduce training time. Using a loss rate, large changes are made at the beginning of the training procedure when larger learning rate values are used and decreasing the learning rate such that a smaller rate and smaller training updates are made to weights later in the training procedure.

The model is used as a function approximator to estimate the action-value function, q-value. A convolutional neural network is the best mode of use. However, any other model may be substituted with the convolutional neural network (CNN), (e.g. recurrent neural network (RNN), logistic regression model, etc.).

Non-linear function approximators, such as neural networks with weight θ make up a Q-network which can be trained by minimizing a sequence of loss functions, Lᵢ(θᵢ) that change at each iteration i,

Lᵢ(θᵢ)=E_{s,a˜ρ(·)}[(yᵢ−Q(s, a; θ)²)

where yᵢ=E_{s,a˜ρ(·); ś˜ξ}┌(r+ [symbol] Q(śá; Θᵢ₋₁)|s, a)┐ is the target for iteration i and ρ(s, a) is a probability distribution over states s or in this embodiment sentences s of the discourse. and actions a such that it represents a discourse-action distribution. The parameters from the previous iteration θᵢ are held fixed when optimizing the loss function, Lᵢ(θᵢ). Unlike the fixed targets used in supervised learning, the targets of a neural network depend on the network weights. Taking the derivative of the loss function with respect to the weights yields,

∇_{Θ}_{ᵢ}Lᵢ(Θᵢ)= [symbol] ┌(r+ [symbol] Q(śá; Θᵢ₋₁)−Q(s, a; Θᵢ))∇_{Θ}_{ᵢ}Q(s, a; Θᵢ)┐

It is computationally prohibitive to compute the full expectation in the above gradient; instead it is best to optimize the loss function by stochastic gradient descent. The Q-learning algorithm is implemented with the weights being updated after an episode, and the expectations are replaced by single samples from the sentence-action distribution, ρ(s, a) and the emulator ξ.

The algorithm is model-free which means that is does not construct an estimate of the emulator ξ but rather solves the reinforcement-learning task directly using samples from the emulator ξ. It is also off-policy meaning that it follows ε-greedy policy which ensures adequate exploration of the state space while learning about the greedy policy a=maxₐQ(s, a; θ).

A CNN was configured with a convolutional layer equal to the product of the number of features per word and the maximum words per sentence, a filter of 2, and a kernel size of 2. The filters specify the dimensionality of the output space. The kernel size specifies the length of the 1D convolutional window. One-dimensional max pooling with a pool size of 2 was used for the max-pooling layer of the CNN. The model used the piecewise Huber loss function and adaptive learning rate optimizer, RMSprop with the loss rate, η hyperparameter.

After the model is initialized as an attribute of the agent, a set of actions are defined that could be taken for words belonging to a word class that are in one or more sentences of the discourse. The model is off-policy such that it randomly selects an action when the random number, r [0,1] is less than hyperparameter epsilon ε. It selects the optimal policy and returns the argmax of the q-value when the random number, r [0,1] is greater than the hyperparameter epsilon ε. After each episode epsilon ε is decayed by a factor ε_decay, a module is defined to decay epsilon ε. Finally, a module is defined to take a vector of word embeddings and fit a model to the word embeddings using a target value.

One of the embodiments provides a way in which to map a sentence to its word-embedding vector. Word embedding comes from language modeling in which feature learning techniques map words to vectors of real numbers. Word embedding allows words with similar meaning to have similar representation in a lower dimensional space. Converting words to word embeddings is a necessary pre-processing step in order to apply machine learning algorithms which will be described in the accompanying drawings and descriptions. A language model is used to train a large language corpus of text in order to generate word embeddings.

Approaches to generate word embeddings include frequency-based embeddings and prediction based embeddings. Popular approaches for prediction-based embeddings are the CBOW (Continuous Bag of Words) and skip-gram model which are part of the word2vec gensim python packages. The CBOW in the word2vec python package on the Wikipedia language corpus was used.

A sentence is mapped to its word-embedding vector. First a large language corpus (e.g. English Wikipedia 20180601) is trained on the word2vec language model to generate corresponding word embeddings for each word. Word embeddings were loaded into memory with a corresponding dictionary that maps words to word embeddings. The number of features per word was set equal to 128 which is the recommended standard. A numeric representation of a sentence was initialized by generating a range of indices from 0 to the product of the number of features per word and the max words per sentence. Finally a vector of word embeddings for an input sentence is returned to the user.

One of the embodiments provides an environment with a current state, which is the discourse that may or may not have been modified by the agent. The environment is also provided with the POS-tagged discourse and a reset state that restores the sentence to its original version before the agent performed actions. The environment is initialized with a maximum number of words per sentence.

One of the embodiments provides a reward module that returns a negative reward r− if the sentence length in a discourse is equal to zero; it returns a positive reward r+ if a logical engine is able to derive the conclusion of the discourse; and returns a negative reward r− if the logical engine is unable to derive the conclusion of the discourse.

At operation, the discourse is provided as input to a reinforcement-learning algorithm a set of logical equations is generated in real-time from the discourse. A set of logical equations is categorized as assumptions and another set is categorized as a conclusion. The discourse and the logical state represent an environment. An agent is allowed to interact with the words, punctuation, and/or characters that belong to a word class where the words belong to one or more of the sentences in the discourse and receive the reward. In the present embodiment, at operation the agent is incentivized to perform actions to the sentence that result in logically correct discourse.

First a min size, batch size, number of episodes, and number of operations are initialized in the algorithm. The algorithm then iterates over each episode from the total number of episodes; for each episode e, the discourse s (state), is reset from the environment reset module to the original discourse that was the input to the algorithm. The algorithm then iterates over k total number of operations; for each operation the discourse s is passed to the agent module act. A number, r is randomly selected between 0 and 1, such that if r is less than epsilon, the total number of actions, nₜₒₜₐₗ is defined such that nₜₒₜₐₗ=nₐ^{W}^{ₛ} where nₐ is the number of actions and wₛ is the words in the sentence belong to a discourse s. An action a, is randomly selected between a range of 0 and nₜₒₜₐₗ and the action a, is returned from the agent module act.

Actions are defined by word classes, FIGS. 6A, 6B, 7A, 7B, 8A, 8B, 9A, & 9B provided examples of word classes and actions that could be performed on the words belonging to a word class such that the words are part of one or more sentences of the discourse. An example of this is shown in FIG. 8A where a word class is defined as antonyms belonging to the ‘heart-blood’ edge node such that an action is performed swapping the word ‘toward’ with it's antonym ‘away’ in the set of logical equations and corresponding discourse.

After an action a, is returned it is passed to the environment. Based on the action a, a vector of subactions or a binary list of 0s and 1s for the length of the discourse s is generated. After selecting subactions for each word in a discourse s the agent generates a new discourse s2 from executing each subaction on each word in word class of the discourse s.

A set of logical equations is generated for the discourse s2 creating a computer program for which the discourse s2 is evaluated. If a logical conclusion is inferred from discourse a positive reward r+ is returned otherwise a negative reward r− is returned. If k, which is iterating through the number of operations is less than the total number of operations a flag terminate is set to False otherwise set flag terminate to True. For each iteration k, append the discourse s, before action a, the reward r, the new discourse s2 after action a, and the flag terminate to the tuple list pool (e.g. Pool of states 204). If k<number of operations repeat previous steps else call the agent module decay epsilon, e by the epsilon decay function _decay.

Epsilon e is decayed by the epsilon decay function _decay and epsilon e is returned. If the length of the list of tuples pool is less than the min size repeat steps previous steps again. Otherwise randomize a batch from the pool. Then for each index in the batch set the target=r, equal to the reward r for the batch at that index; generate the word embedding vector s2_vec for each word in discourse 2, s2 and word embedding vector s_vec for each word in discourse s. Next make model prediction X using the word embedding vector s_vec. If the terminate flag is set to False make model prediction X₂ using the word embedding vector s2_vec. Using the model prediction X₂ compute the q-value using the Bellman equation: q−value=r+γmaxX₂ and then set the target to the q-value. If the terminate flag is set to True call agent module learn and pass s vec and target and then fit the model to the target.

The CNN is trained with weights θ to minimize the sequence of loss functions, Lᵢ(θᵢ) either using the target as the reward or the target as the q-value derived from Bellman equation. A greedy action a, is selected when the random number r is greater than epsilon. The word embedding vector s_vec is returned for the discourse s and the model then predicts X using the word embedding vector s_vec and sets the q-value to X. An action is then selected as the argmax of the q-value and action a returned.

Reinforcement Learning Does Not Require Paired Datasets.

The benefits of a reinforcement learning system 110 vs. supervised learning are that it does not require large paired training datasets (e.g. on the order of 10⁹ to 10¹⁰ (Goodfellow I. 2014)). Reinforcement learning is a type of on-policy machine learning that balances between exploration and exploitation. Exploration is testing new things that have not been tried before to see if this leads to an improvement in the total reward. Exploitation is trying things that have worked best in the past. Supervised learning approaches are purely exploitative and only learn from retrospective paired datasets.

Supervised learning is retrospective machine learning that occurs after a collective set of known outcomes is determined. The collective set of known outcomes is referred to as paired training dataset such that a set of features is mapped to a known label. The cost of acquiring paired training datasets is substantial. For example, IBM's Canadian Hansaard corpus with a size of 10⁹ cost an estimated $100 million dollars (Brown 1990).

In addition, supervised learning approaches are often brittle such that the performance degrades with datasets that were not present in the training data. The only solution is often reacquisition of paired datasets which can be as costly as acquiring the original paired datasets.

From the description above, a number of advantages of some embodiments of the reinforcement learning logic-engine become evident:

(a) The reinforcement learning logic-engine is unconventional in that it represents a combination of limitations that are not well-understood, routine, or conventional activity in the field as it combines limitations from independent fields of logic, automated theorem proving and reinforcement learning.

(b) The logic engine can be considered a generalizable reward mechanism in reinforcement learning. The limitation of using logical form defined by formal language theory enables generalization across any new environment, which is represented as a discourse in MDP.

(c) An advantage of the reinforcement learning logic-engine is that reinforcement learning is only applied to a limited scope of the environment. An aspect of the reinforcement learning logic engine is that actions are defined as a word class of the discourse. The reinforcement learning agent is constrained to perform actions on word classes.

(d) An advantage of the reinforcement learning logic-engine is that it scalable and can process large datasets creating significant cost savings.

(e) Several advantages of the reinforcement learning logic-engine applied to evaluating medication prescriptions are the following: provide an automated error proof-reading system, prevent medication error, save lives, prevent future morbidities, an improvement in trust between patients and doctors, and additional unforeseeable benefits.

### INDUSTRIAL APPLICABILITY

The reinforcement learning logic-engine could be applied to the following use cases in the medical field:

1) A pharmacist receives an illegible written prescription from a doctor. The pharmacist scans in the prescription, and executes software to convert the scanned image to written text. The pharmacist ‘copy & paste’ the written text and modifies the word to what he believes to be the drug Lipitor before executing the software. The software returns a correction to the pharmacist suggesting that the drug may instead be Lisinopril and instructing the pharmacist to contact the doctor.

2) A doctor types up a prescription in a hurry as he is being called into surgery. The prescription is automatically processed through the software on the hardware and output is provided on the display screen. After surgery the doctor receives an alert, a text message from the software that the suggested medication may cause complication for that patient who has a liver condition.

3) A nurse is handed a prescription she has a suspicion that it may contain an error. She immediately queries the software by typing the prescription with a keyboard into the text area provided by the software and then clicking the submit button. The software returns that the prescription is logical. The nurse is still skeptical so she scrolls through the series of premises and conclusion that was generated by the software. Clicking on a particular premise that she was unfamiliar with the software triggers the original sentences and source of the text, which derived that relationship. She is now able to read a most recent medical journal that confirms that this particular drug is being used to treat hypertension for patients having arrhythmias. The nurse feels reassured that this is indeed the correct prescription and she continues with ordering the prescription. Later she consults who tells her confirms the results of recent medical studies.

4) A patient is concerned that medical prescription is incorrect. She logs into her patient portal where she is provided with an icon labeled medication error prevention. She deploys the third party app from the patient portal and enters her medical background history and medication reaction list as assumptions into the software. Using this information and peer-reviewed medical content the system trains and generates a set of logical proofs that are personalized based on the patient's data. The patient is then prompted to provide in a text area the medical prescription. Upon submitting the query the patient is alerted that medical prescription is inaccurate and a text message is automatically sent to the doctor. After 15 minutes the patient receives a call from a nurse at the doctor's office who instructs the patient to not take the prescribed medication.

Other specialty fields that could benefit from a logic correction system include: legal, finance, engineering, information technology, science, arts & music, and any other field that uses jargon.

1. A reinforcement learning system, comprising:
one or more processors; and
one or more programs residing on a memory and executable by the one or more processors, the one or more programs configured to:
perform actions from a set of available actions on a state wherein the state is a sentence;
select an action to maximize an expected future value of a reward function; and, wherein the reward function depends on a logic-engine that upon receiving a logical sentence returns a positive reward and upon receiving an illogical sentence returns a negative reward;
provide the reinforcement learning agent with a pool of states, actions, and rewards and a function approximator wherein using the function approximator the reinforcement learning agent predicts the best action to take resulting in maximum reward;
wherein an agent optimizes a policy such the agent learns modifications to restore the sentence to a logical state.

2. The system of claim 1, wherein the logic engine consisting of a automated theorem prover processes input sentences according to a set of logical equations derived from a discourse and the sentence, wherein the automated theorem prover takes the logical equations as the premise and infers a proof.

3. The system of claim 2, wherein the logic engine consisting of the automated theorem prover executes a logical equation or logical equations derived from the sentence stored in memory against a set of logical equations derived from a discourse stored in memory on a processor and returns the state of the sentence as logical or illogical.

4. The system of claim 3, wherein the logical equations consist of negated relationships that are determined by a symmetrical axis or a plurality of symmetrical axes in a network graph.

5. The system of claim 4, wherein one or more sentence and groups are used to construct a network.

6. The system of claim 5, wherein the symmetry of the network is used to create negated relationships among nodes in the network.

7. The system of claim 6, wherein a word polarity score is a measure of symmetry between two nodes in the network.

8. The system of claim 7, wherein a word polarity score is used to rank symmetrical node relationships wherein the top ranked symmetrical node relationships are used to generate the negated relationships.

9. The system of claim 4, wherein the negated relationships are formulated as a formal logic, such that a set of logical equations is generated.

10. The system of claim 9, wherein the negated relationships are formulated as a propositional logic, such that a set of propositional logic equations is generated.

11. The system of claim 10, wherein an automated propositional logic theorem prover evaluates the propositional logic equations and returns a positive reward if the one or more sentence is logical and a negative reward if the one or more sentence is nonsensical.

12. The system of claim 9, wherein the negated relationships are formulated as a first-order logic, such that a set of logic equations is generated.

13. The system of claim 12, wherein an automated first-order logic theorem prover evaluates the first-order logic equations and returns a positive reward if the one or more sentence is logical and a negative reward if the one or more sentence is nonsensical.

14. The system of claim 9, wherein the negated relationships are formulated as a second-order logic, such that a set of logic equations is generated.

15. The system of claim 14, wherein an automated second-order logic theorem prover evaluates the second-order logic equations and returns a positive reward if the one or more sentence is logical and a negative reward if the one or more sentence is nonsensical.

16. The system of claim 9, wherein the negated relationships are formulated as a higher-order logic, such that a set of logic equations is generated.

17. The system of claim 16, wherein an automated higher-order logic theorem prover evaluates the higher-order logic equations and returns a positive reward if the one or more sentence is logical and a negative reward if the one or more sentence is nonsensical.

18. The system of claim 4, wherein the logical equations are categorized into assumptions and conclusions.

19. The system of claim 18, wherein a user provides the logical equations categorized as assumptions.

20. A reinforcement learning system, comprising:
one or more processors; and
one or more programs residing on a memory and executable by the one or more processors, the one or more programs configured to:
select an action to maximize an expected future value of a reward function; and, wherein the reward function depends on a logic-engine that upon receiving a logical sentence returns a positive reward and upon receiving an illogical sentence returns a negative reward;
provide the reinforcement learning agent with a pool of states, actions, and rewards and a function approximator wherein using the function approximator the reinforcement learning agent predicts the best action to take resulting in maximum reward;
upon obtaining an learning rate above a threshold save the weights of the function approximator to memory;
wherein an optimized policy is obtained such that the reinforcement learning agent has generated a mental map of the logic of the one or more sentences.

21. The system of claim 20, wherein the mental map can be transferred to a new system by saving the weights of the convolutional neural network used as a function approximator.

22. A logical correction system, comprising:
input sentence;
one or more processors; and
one or more programs residing on a memory and executable by the one or more processors, the one or more programs configured to:
perform reinforcement learning utilizing an automated theorem prover as the reward mechanism wherein an optimal policy is achieved when a minimum number of edits results in a logical sentence;

23. A method for reinforcement learning, comprising the steps of:
receiving one or more sentences;
performing actions from a set of available actions on a state wherein the state is a sentence;
selecting an action to maximize the expected future value of a reward function; wherein the reward function depends on at least partly on: restoring the sentences to a logical state. providing the reinforcement learning agent with a pool of states, actions, and rewards and a function approximator wherein using the function approximator the reinforcement learning agent predicts the best action to take resulting in maximum reward;

24. The method of claim 23, wherein the logic engine consisting of a automated theorem prover that processes input sentences according to a set of logical equations derived from a discourse and the sentence, wherein the automated theorem prover takes the logical equations as the premise and infers a proof.

25. The system of claim 24, wherein the logic engine consisting of the automated theorem prover executes a logical equation derived from the sentence stored in memory against a set of logical equations derived from a discourse stored in memory on a processor and returns the state of the sentence as logical or illogical.

26. The system of claim 25, wherein the logical equations consist of negated relationships that are determined by a symmetrical axis or a plurality of symmetrical axes in a network graph.

27. The system of claim 26, wherein the logical equations are categorized into assumptions and conclusions.

28. A real-time logic engine, comprising:
one or more sentences;
a physical hardware device consisting of a memory unit and processor;
a software consisting of a computer program or computer programs;
an output signal that indicates that one or more sentences is logical or one or more sentences is nonsensical;
wherein one or more processors; and
one or more programs residing on a memory and executable by the one or more processors, the one or more programs configured to:
receive one or more sentences;
generate a network from the one or more sentences;
identify symmetry in the network;
rank the symmetry in the network;
negate the ranked symmetry of the network into logical relationships;
generate logical equations by formalizing logical relationships into a formal logic;
infer a proof by evaluating the logical equations with an automated theorem prover;
wherein modifications made to one or more sentences can be evaluated to determine if the modifications results in a logical or nonsensical sentence.
